(19) United States
(12) Patent Application Publication
(10) Pub. No.: US 2024/0120683 A1
(43) Pub. Date: Apr. 11, 2024

(54) ELECTRICAL CONNECTOR ASSEMBLY

(71) Applicant: EZCONN CORPORATION, New Taipei City (TW)

(72) Inventors: Kai-Wei HUANG, New Taipei City (TW); Kai-Chih WEI, New Taipei City (TW)

(73) Assignee: EZCONN CORPORATION, New Taipei City (TW)

(21) Appl. No.: 18/377,031

(22) Filed: Oct. 5, 2023

Related U.S. Application Data
(60) Provisional application No. 63/415,173, filed on Oct. 11, 2022.

(51) Int. Cl. H01R 13/622; H01R 13/629

(52) U.S. Cl. CPC H01R 13/622; H01R 13/629

(57) ABSTRACT

An electrical connector assembly includes an electrical connector and a rotatable sleeve. The electrical connector includes a casing and a coupling component. The coupling component is rotatably disposed on the casing, and the coupling component has at least one first ratchet tooth. The rotatable sleeve is rotatably disposed on the casing. The rotatable sleeve has at least one second ratchet tooth, the second ratchet tooth of the rotatable sleeve is meshed with the first ratchet tooth of the coupling component merely along a first direction for rotating the coupling component relative to the casing.

### CROSS-REFERENCE TO RELATED APPLICATIONS

This non-provisional application claims priority under 35 U.S.C. § 119(a) on Provisional Application No(s). 63/415,173 filed in U.S.A. on Oct. 11, 2022, the entire contents of which are hereby incorporated by reference.

### TECHNICAL FIELD

The disclosure relates to an electrical connector assembly.

### BACKGROUND

In general, two cables or a cable and an electronic device are connected to each other by two connectors. In order to prevent an irrelevant person from detaching the connectors from each other for stealing the cables or the electronic device, the connectors are provided with an anti-theft mechanism. However, this anti-theft mechanism requires a specific tool for both the detachment and assembly of the connectors, which is inconvenient and troublesome especially during the assembly of the connectors. Therefore, how to solve the aforementioned issue is one of the crucial topics in this field.

### SUMMARY

The disclosure provides an electrical connector assembly which is convenient in installation.

One embodiment of the disclosure provides an electrical connector assembly. The electrical connector assembly includes an electrical connector and a rotatable sleeve. The electrical connector includes a casing and a coupling component. The coupling component is rotatably disposed on the casing, and the coupling component has at least one first ratchet tooth. The rotatable sleeve is rotatably disposed on the casing. The rotatable sleeve has at least one second ratchet tooth, the second ratchet tooth of the rotatable sleeve is meshed with the first ratchet tooth of the coupling component merely along a first direction for rotating the coupling component relative to the casing.

According to the electrical connector assembly as described above, the second ratchet tooth of the rotatable sleeve is engaged with the first ratchet tooth of the coupling component merely in the first direction for rotating the coupling component relative to the casing, such that the user may rotate the rotatable sleeve with fingers to assemble the coupling component with a corresponding device without using an additional tool. Therefore, the electrical connector can be assembled with the corresponding device in a toolless manner. In addition, the second ratchet tooth of the rotatable sleeve is engaged with the first ratchet tooth of the coupling component merely in the first direction for rotating the coupling component relative to the casing; that is, when the rotatable sleeve is rotated along a direction opposite to the first direction, the rotatable sleeve is unable to rotate the coupling component. Therefore, even though an irrelevant person rotates the rotatable sleeve along the direction opposite to the first direction, the coupling component can be prevented from being removed from the corresponding device. Accordingly, the electrical connector assembly is not only convenient in installation but also provides an anti-theft effect.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an electrical connector assembly according to one embodiment of the disclosure;

FIG. 2 is an exploded view of the electrical connector assembly in FIG. 1;

FIG. 3 is a front view of the electrical connector assembly in FIG. 1;

FIG. 4 is a cross-sectional view of the electrical connector assembly taken along a line 4-4 in FIG. 3;

FIG. 5 is a cross-sectional view of the electrical connector assembly taken along a line 5-5 in FIG. 3;

FIG. 6 is a front view of a coupling component in FIG. 2;

FIG. 7 is a front view of a rotatable sleeve in FIG. 2; and

FIG. 8 is a front view of the electrical connector assembly in FIG. 3 when the rotatable sleeve is rotated along a second direction.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

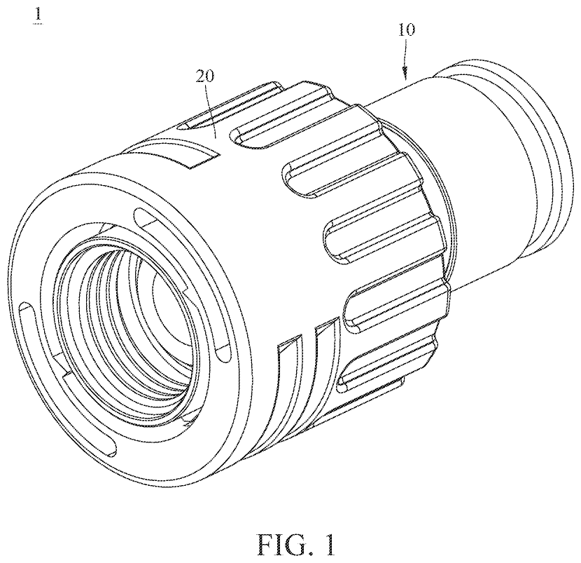

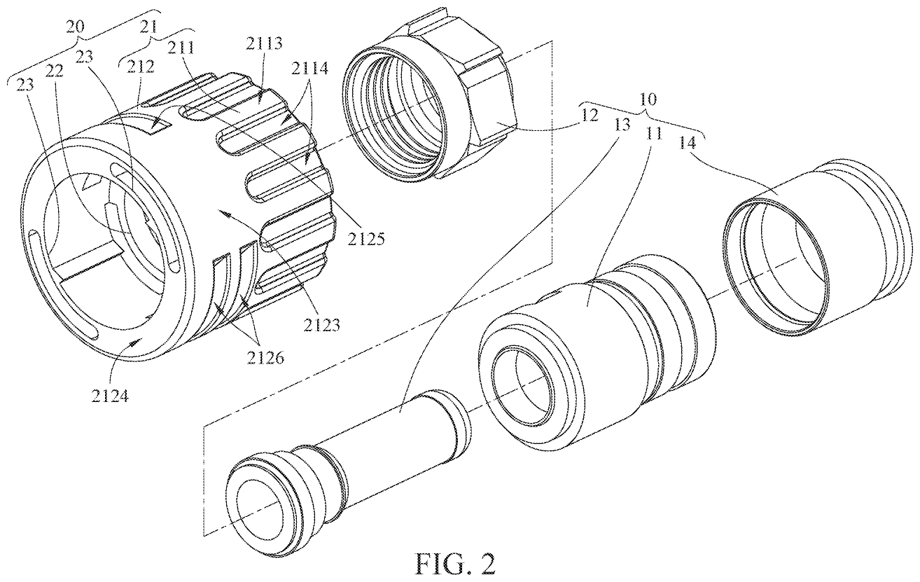

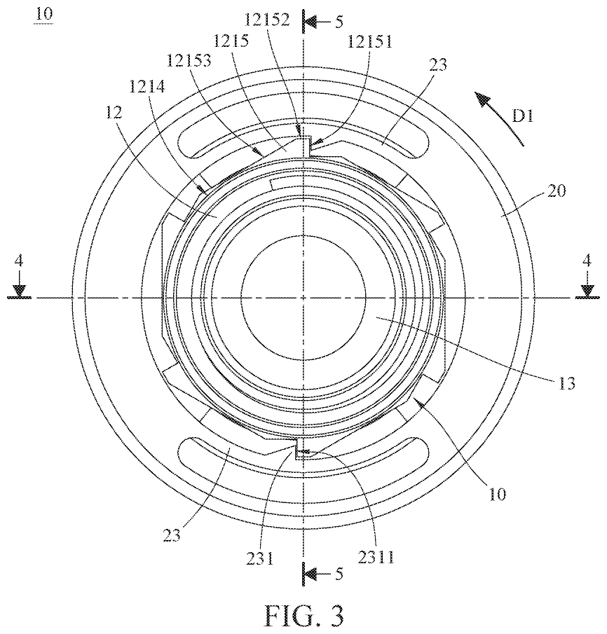

Referring to FIGS. 1 to 3, FIG. 1 is a perspective view of an electrical connector assembly 1 according to one embodiment of the disclosure, FIG. 2 is an exploded view of the electrical connector assembly 1 in FIG. 1, and FIG. 3 is a front view of the electrical connector assembly 1 in FIG. 1.

In this embodiment, the electrical connector assembly 1 includes an electrical connector 10 and a rotatable sleeve 20. The electrical connector 10 includes a casing 11 and a coupling component 12. In addition, the electrical connector 10 may further include an inner tube 13 and a fastener 14.

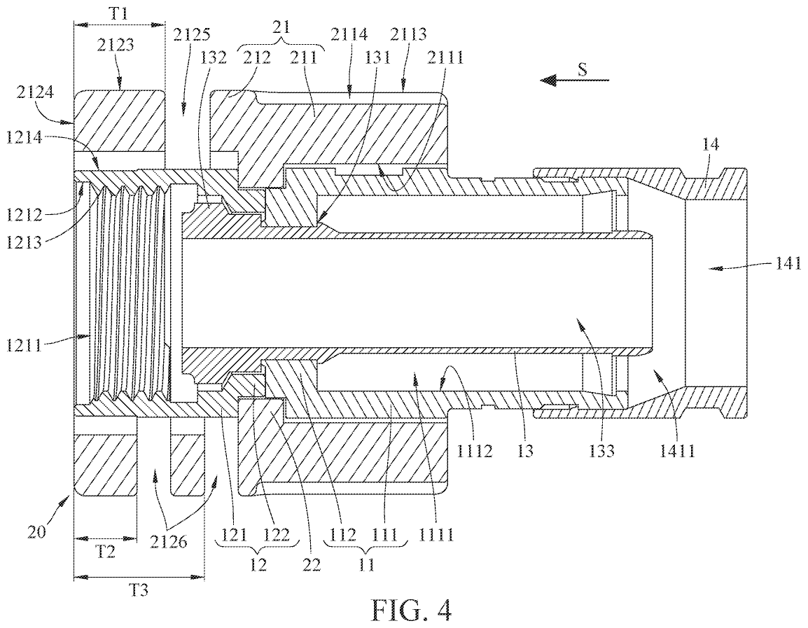

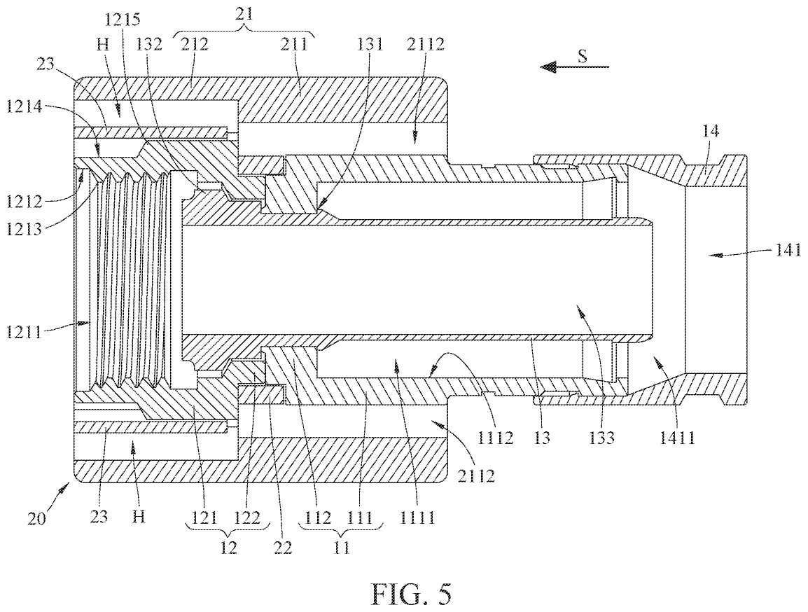

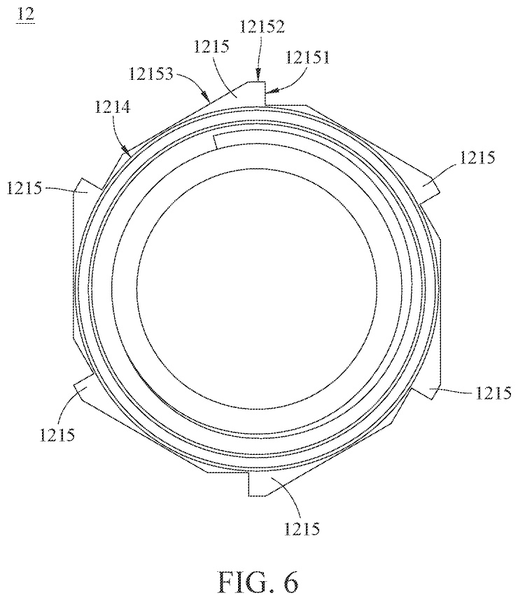

Then, referring to FIGS. 4 to 6, FIG. 4 is a cross-sectional view of the electrical connector assembly 1 taken along a line 4-4 in FIG. 3, FIG. 5 is a cross-sectional view of the electrical connector assembly 1 taken along a line 5-5 in FIG. 3, and FIG. 6 is a front view of a coupling component 12 in FIG. 2.

The casing 11 includes a first annular wall portion 111 and a first annular protrusion portion 112. The first annular wall portion 111 has a first inner space 1111 and a first inner surface 1112. The first inner surface 1112 surrounds and forms the first inner space 1111, and the first annular protrusion portion 112 protrudes from the first inner surface 1112 and extends along an axial direction of the first annular wall portion 111 so as to protrude from one end of the first annular wall portion 111.

The coupling component 12 includes a second annular wall portion 121 and a second annular protrusion portion 122. The second annular wall portion 121 has a second inner space 1211, a second inner surface 1212, an inner threaded structure 1213, an outer surface 1214 and a plurality of first ratchet teeth 1215. The second inner surface 1212 surrounds and forms the second inner space 1211, the inner threaded structure 1213 is located on the second inner surface 1212. The inner threaded structure 1213 of the second annular wall portion 121 of the coupling component 12 is configured to be assembled with an outer threaded structure of an electrical connector of an electronic device or a cable (not shown). The outer surface 1214 faces away from the second inner surface 1212, and the first ratchet teeth 1215 are located on the outer surface 1214 and are arranged along a circumferential direction of the coupling component 12. Each of the first ratchet teeth 1215 has an engagement surface 12151, a contact surface 12152 and an inclined guide surface 12153. In each of the first ratchet teeth 1215, the engagement surface 12151 is connected to the inclined guide surface 12153 via the contact surface 12152, the engagement surface 12151 is, for example, perpendicular to the contact surface 12152, and the inclined guide surface 12153 is inclined relative to the contact surface 12152. The second annular protrusion portion 122 protrudes from the second inner surface 1212 of the second annular wall portion 121 and extends along an axial direction of the second annular wall portion 121 so as to protrude from one end of the second annular wall portion 121.

The inner tube 13 has an annular engagement groove 131 and an annular flange 132. The inner tube 13 is disposed through the second inner space 1211 of the coupling component 12 and is inserted into the first inner space 1111 of the casing 11. The first annular protrusion portion 112 of the casing 11 is engaged with the annular engagement groove 131 of the inner tube 13, and the second annular protrusion portion 122 of the coupling component 12 is clamped by and located between the annular flange 132 of the inner tube 13 and the first annular protrusion portion 112 of the casing 11, such that the coupling component 12 is rotatably positioned on the casing 11 via the inner tube 13. In addition, the inner tube 13 has a third inner space 133, the third inner space 133 of the inner tube 13 and the first inner space 1111 of the first annular wall portion 111 of the casing 11 are configured for a cable to be installed thereinto.

The fastener 14 has a sleeve space 141. The fastener 14 is sleeved on one end of the first annular wall portion 111 of the casing 11 located farther away from the coupling component 12, such that the end of the first annular wall portion 111 of the casing 11 located farther away from the coupling component 12 is located in the sleeve space 141. The sleeve space 141 of the fastener 14 has a tapered portion 1411. When the fastener 14 is moved towards the coupling component 12 (e.g., a direction S), the fastener 14 can force the casing 11 to deformed inwards, such that the end of the first annular wall portion 111 of the casing 11 located farther away from the coupling component 12 can press against the cable.

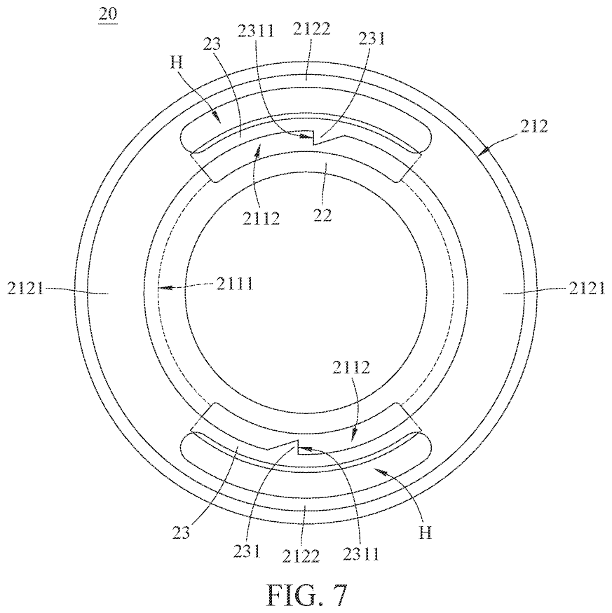

Then, referring to FIGS. 4, 5 and 7, FIG. 7 is a front view of the rotatable sleeve in FIG. 2.

The rotatable sleeve 20 is, for example, made of plastic material. The rotatable sleeve 20 includes an outer annular portion 21, an inner annular portion 22 and two flexible portions 23. The outer annular portion 21 includes a rear part 211 and a front part 212 axially connected to each other. The rear part 211 of the outer annular portion 21 has an inner surface 2111 and two recesses 2112. The recesses 2112 are respectively recessed from two opposite sides of the inner surface 2111, and the recesses 2112 extends from one end of the rear part 211 located farther away from the front part 212 to a place where the rear part 211 and the front part 212 are connected. The inner annular portion 22 is connected to a portion of the inner surface 2111 of the rear part 211 of the outer annular portion 21 without the recesses 2112. The front part 212 of the outer annular portion 21 includes two thick sections 2121 and two thin sections 2122. Thickness of the thick sections 2121 are greater than thickness of the thin sections 2122. The thick sections 2121, the thin sections 2122 and the flexible portions 23 are arranged along a circumferential direction of the rotatable sleeve 20. Two sides of the thick sections 2121 are connected to each other via one of the thin sections 2122 and one of the flexible portions 23, and other two sides of the thick sections 2121 are connected to each other via the other one of thin sections 2122 and the other one of the flexible portions 23. One of the flexible portions 23 and one of the thin sections 2122 are located opposite to the other one of the flexible portions 23 and the other one of the thin sections 2122. The flexible portions 23 are respectively spaced apart from the thin sections 2122 and are located closer to a center of the rotatable sleeve 20 than the thin sections 2122. The flexible portions 23, the thin sections 2122 and the thick sections 2121 together form two deformable holes H located opposite to each other. The deformable holes H respectively communicate with the recesses 2112. Each of the flexible portions 23 has a second ratchet tooth 231, and this second ratchet tooth 231 has an engagement surface 2311.

In this embodiment, the rear part 211 of the outer annular portion 21 of the rotatable sleeve 20 may further have an outer annular surface 2113 and a plurality of anti-slip structures 2114. The anti-slip structures 2114 are, for example, recesses and are recessed from the outer annular surface 2113. The anti-slip structures 2114 can increase friction between the rotatable sleeve 20 and fingers gripping the rotatable sleeve 30 for facilitating the rotatable sleeve 20 to be rotated by the fingers. Note that the anti-slip structures 2114 are not restricted to being the recesses; in some other embodiments, the anti-slip structures may be protrusions. In addition, the anti-slip structures 2114 are optional and may be omitted as required.

In addition, the front part 212 of the outer annular portion 21 of the rotatable sleeve 20 has an outer annular surface 2123, an end surface 2124, a first tool hole 2125 and two second tool holes 2126. One side of the outer annular surface 2123 is connected to the outer annular surface 2113, and the end surface 2124 is connected to a periphery of another side of the outer annular surface 2123. The first tool hole 2125 and the second tool holes 2126 are respectively recessed from two opposite sides of the outer annular surface 2123. A distance T1 from the first tool hole 2125 to the end surface 2124 is different from distances T2 and T3 from the second tool holes 2126 to the end surface 2124, and the distances T2 and T3 from the second tool holes 2126 to the end surface 2124 are different from each other. In other words, the first tool hole 2125 is asymmetric to the second tool holes 2126.

The inner annular portion 22 of the rotatable sleeve 20 is clamped by the first annular wall portion 111 of the casing 11 and the second annular wall portion 121 of the coupling component 12, and the rear part 211 of the rotatable sleeve 20 surrounds the casing 11, and the front part 212 of the rotatable sleeve 20 surrounds the coupling component 12, such that the first tool hole 2125 and the second tool holes 2126 respectively expose different portions of the coupling component 12.

As shown in FIG. 3, when a user desires to assemble the electrical connector 10 to the electrical connector of the electronic device or the cable (not shown), the user can rotate the rotatable sleeve 20 along a first direction D1, such the engagement surfaces 2311 of the second ratchet teeth 231 of the rotatable sleeve 20 are respectively meshed with the engagement surfaces 12151 of two opposite first ratchet teeth 1215 of the coupling component 12 so as to rotate the coupling component 12 along the first direction D1 and screw the coupling component 12 to engage with the electrical connector of the electronic device or the cable (not shown). As a result, the installation of the electrical connector 10 on the electrical connector of the electronic device or the cable can be performed in a toolless manner.

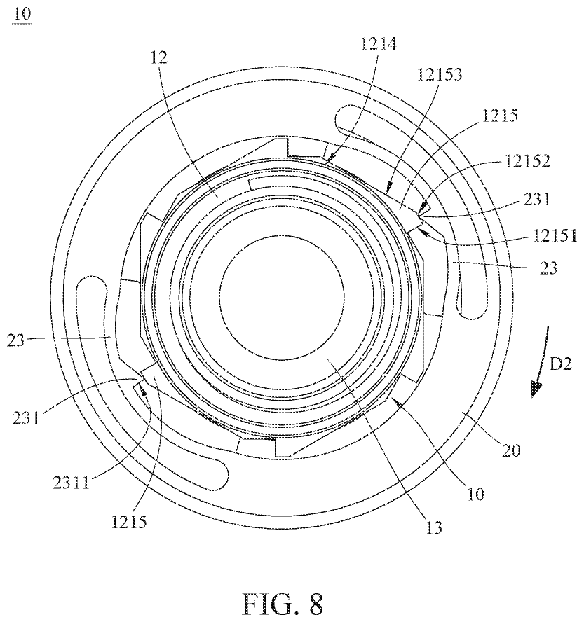

Then, referring to FIG. 8, FIG. 8 is a front view of the electrical connector assembly in FIG. 3 when the rotatable sleeve is rotated along a second direction. When the rotatable sleeve 20 is rotated along a second direction D2 opposite to the first direction D1, the second ratchet teeth 231 of the rotatable sleeve 20 pass through the inclined guide surfaces 12153 of two opposite first ratchet teeth 1215 of the coupling component 12 and then reach the contact surfaces 12152, such that the flexible portions 23 of the rotatable sleeve 20 are deformed. Keeping rotating the rotatable sleeve 20 along the second direction D2 merely makes the second ratchet teeth 231 of the rotatable sleeve 20 climb over the two opposite first ratchet teeth 1215 of the coupling component 12, but not force the coupling component 12 to rotate along the second direction D2, and thus the coupling component 12 is unable to be removed from the electrical connector of the electronic device or the cable (not shown). As a result, even though an irrelevant person rotates the rotatable sleeve 20 along the second direction D2, the coupling component 12 can be prevented from being removed from the electrical connector of the electronic device or the cable. Accordingly, the electrical connector assembly 1 is convenient in installation and provides an anti-theft effect.

In this embodiment, the distance T1 from the first tool hole 2125 to the end surface 2124 is different from the distances T2 and T3 from the second tool holes 2126 to the end surface 2124, and the distance T2 and T3 from the second tool holes 2126 to the end surface 2124 are different from each other. Therefore, when the user desires to remove the electrical connector 10 from the electrical connector of the electronic device or the cable, the user has to engage a specific tool with the first tool hole 2125 and the second tool holes 2126 of the rotatable sleeve 20 for rotating the coupling component 12 along the second direction D2. Therefore, an irrelevant person without this specific tool is unable to rotate the coupling component 12 with a common tool (e.g., a wrench) and thus is unable to remove the coupling component 12 from the electrical connector of the electronic device or the cable, thereby further improving the anti-theft effect.

Note that the quantity of the second tool holes 2126 of the rotatable sleeve 20 is not restricted in the disclosure and may be modified according to actual requirements. In addition, the specific tool is not restricted to being engaged with the first tool hole 2151 and the second tool holes 2126 of the rotatable sleeve 20 to rotate the coupling component 12 along the second direction D2; in some other embodiments, the rotatable sleeve may not have the first tool hole and the second tool holes, and the rotatable sleeve may have other structures for being engaged with the specific tool so as to enable the coupling component to be rotated.

In this embodiment, the deformable holes H located opposite to each other are formed by the thin sections 2122 and the thick sections 2121 of the front part 212 of the outer annular portion 21 and the flexible portions 23 of the rotatable sleeve 20, and the deformable holes H respectively communicate with the recesses 2112 of the rear part 211 of the outer annular portion 21 of the rotatable sleeve 20, which enables the flexible portions 23 to be easily deformed when the second ratchet teeth 231 are pressed by two of the first ratchet teeth 1215 of the coupling component 12.

Note that the recesses 2112 of the rear part 211 of the outer annular portion 21 of the rotatable sleeve 20 are optional structures. When the deformable holes can allow the flexible portions to be easily deformed as the second ratchet teeth are pressed by two of the first ratchet teeth of the coupling component, the recesses of the rear part of the outer annular portion of the rotatable sleeve may be omitted. In some other embodiments, the rotatable sleeve may not have any flexible portion, and the front part of the outer annular portion of the rotatable sleeve may not have any thick section and thin section but have a uniform thickness, and the second ratchet teeth is located at an inner surface the front part. In such a case, when the second ratchet teeth of the rotatable sleeve are pressed by two of the first ratchet teeth of the coupling component, the front part of the outer annular portion of the rotatable sleeve may be elastically deformed directly.

On the other hand, the second ratchet teeth 231 of the rotatable sleeve 20 are restricted to being located opposite to each other, the relative positions of the second ratchet teeth may be modified according to actual requirements. Furthermore, the quantities of the first ratchet teeth 1215 and the second ratchet teeth 231 are not restricted and may be modified according to actual requirements.

Note that the structures of the casing 11, the coupling component 12, the inner tube 13 and the fastener 14 are exemplary and may be modified according to actual requirements. In addition, the inner tube 13 and the fastener 14 of the electrical connector are optional components and may be omitted.

According to the electrical connector assembly as described above, the second ratchet teeth of the rotatable sleeve are engaged with the first ratchet teeth of the coupling component merely in the first direction for rotating the coupling component relative to the casing, such that the user may rotate the rotatable sleeve with fingers to assemble the coupling component with a corresponding device without using an additional tool. Therefore, the electrical connector can be assembled with the corresponding device in a toolless manner. In addition, the second ratchet teeth of the rotatable sleeve are engaged with the first ratchet teeth of the coupling component merely in the first direction for rotating the coupling component relative to the casing; that is, when the rotatable sleeve is rotated along a direction opposite to the first direction, the rotatable sleeve is unable to rotate the coupling component. Therefore, even though an irrelevant person rotates the rotatable sleeve along the direction opposite to the first direction, the coupling component can be prevented from being removed from the electrical connector of the electronic device or the cable. Accordingly, the electrical connector assembly is not only convenient in installation but also provides an anti-theft effect.

Furthermore, in the rotatable sleeve, the distance from the first tool hole to the end surface is different from the distances from the second tool holes to the end surface. Therefore, when the user desires to remove the electrical connector from the electrical connector of the electronic device or the cable, the user has to engage a specific tool with the first tool hole and the second tool hole of the rotatable sleeve for rotating the coupling component. Therefore, an irrelevant person without this specific tool is unable to rotate the coupling component with a common tool (e.g., a wrench) and thus is unable to remove the coupling component from the electrical connector of the electronic device or the cable, thereby further improving the anti-theft effect.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An electrical connector assembly, comprising:
an electrical connector, comprising a casing and a coupling component, wherein the coupling component is rotatably disposed on the casing, and the coupling component has at least one first ratchet tooth; and
a rotatable sleeve, rotatably disposed on the casing, wherein the rotatable sleeve has at least one second ratchet tooth, the at least one second ratchet tooth of the rotatable sleeve is meshed with the at least one first ratchet tooth of the coupling component merely along a first direction for rotating the coupling component relative to the casing.

2. The electrical connector assembly according to claim 1, wherein the rotatable sleeve comprises an outer annular portion and at least one flexible portion connected to each other, the at least one second ratchet tooth is located on the at least one flexible portion; when the rotatable sleeve is rotated along a second direction opposite to the first direction, the at least one first ratchet tooth presses against the at least one second ratchet tooth so as to deform the at least one flexible portion.

3. The electrical connector assembly according to claim 2, wherein the at least one first ratchet tooth comprises a plurality of first ratchet teeth arranged along a circumferential direction of the coupling component, the at least one second ratchet tooth comprises two second ratchet teeth, the at least one flexible portion comprises two flexible portions, the two flexible portions are located opposite to each other, and the two second ratchet teeth are respectively located on the two flexible portions, and the two second ratchet teeth respectively correspond to two of the plurality of first ratchet teeth located opposite to each other.

4. The electrical connector assembly according to claim 1, wherein the rotatable sleeve has an outer annular surface, a first tool hole and at least one second tool hole, the first tool hole and the at least one second tool hole are respectively recessed from different sides of the outer annular surface and expose different portions of the coupling component.

5. The electrical connector assembly according to claim 4, wherein the rotatable sleeve further has an end surface, the end surface is connected to a periphery of the outer annular surface, and a distance from the first tool hole to the end surface is different from a distance from the at least one second tool hole to the end surface.

6. The electrical connector assembly according to claim 5, wherein the at least one second tool hole comprises two second tool holes, and distances from the two second tool holes to the end surface are different from each other.

7. The electrical connector assembly according to claim 4, wherein the first tool hole and the at least one second tool hole ae respectively recessed from two opposite sides of the outer annular surface.

8. The electrical connector assembly according to claim 1, wherein the rotatable sleeve has an outer annular surface and a plurality of anti-slip structures located on the outer annular surface.

9. The electrical connector assembly according to claim 1, wherein the rotatable sleeve is made of plastic material.

10. The electrical connector assembly according to claim 1, wherein the coupling component has an inner threaded structure.
